(19) United States
(12) Patent Application Publication
(10) Pub. No.: US 2024/0201116 A1
(43) Pub. Date: Jun. 20, 2024

(54) APPARATUSES, METHODS, AND COMPUTER PROGRAM PRODUCTS FOR DETERMINING AN AMOUNT OF GREENHOUSE GAS EMITTED

(71) Applicant: Honeywell International Inc., Charlotte, NC (US)

(72) Inventors: Shahrul Azman Bin Zainal Abidin, Kuala Lumpur (MY); Madhukar Madhavamurthy Gundappa, Bangalore (IN); Ramesh Murugan Natarajan, Bangalore (IN)

(21) Appl. No.: 18/116,123

(22) Filed: Mar. 1, 2023

(30) Foreign Application Priority Data
Dec. 20, 2022 (IN) 202211073865

(51) Int. Cl. G01N 25/48; G06Q 50/26

(52) U.S. Cl. CPC G01N 25/4873; G06Q 50/26

(57) ABSTRACT

Methods, apparatuses, and computer program products for determining amounts of greenhouse gas emissions are provided. For example, a computer-implemented method may include determining an amount of each of a plurality of constituent components of a fuel being used, determining one or more properties of the fuel, generating one or more emission factors for the fuel, determining an amount of the fuel used, and using the one or more generated emission factors, determining an emitted amount of a corresponding one or more greenhouse gases. Each emission factor corresponds to a different greenhouse gas. Each emission factor is generated using at least one of the constituent components and at least one of the properties.

### CROSS-REFERENCE TO RELATED APPLICATIONS

This application claims priority to and the benefit of foreign India Patent Application Serial No. 202211073865, filed on Dec. 20, 2022 and entitled “Apparatuses, Methods, And Computer Program Products For Determining An Amount Of Greenhouse Gas Emitted,” each of which is incorporated herein by reference in its entirety.

### TECHNOLOGICAL FIELD

Embodiments of the present disclosure generally relate to determining amounts of greenhouse gas emissions, and specifically to using emission factors for determining amounts of greenhouse gas emissions.

### BACKGROUND

For a variety of reasons, businesses may need to track emissions of greenhouse gases (GHGs) that occur during commercial/industrial activities, such as oil and natural gas production, heating, electricity generation, and manufacturing. Such greenhouse gases include, but are not limited to carbon dioxide, nitrous oxide, and methane.

Emission factors (EFs) are commonly used to calculate greenhouse gas emissions. An emission factor is a representative value that attempts to relate the quantity of a pollutant released to the atmosphere with an activity associated with the release of that pollutant. These factors are usually expressed as the weight of pollutant divided by a unit weight, volume, distance, or duration of the activity emitting the pollutant (e.g., kilograms of particulate emitted per megagram of coal burned). Emission factors facilitate estimation of emissions from various sources of air pollution.

To estimate emissions, an emission factor is multiplied by the corresponding activity data such as the production output of a manufacturing plant, the energy contained in a mass of fuel combusted, or the amount of electricity consumed.

Each emission factor is specific to a greenhouse gas and an activity. Emission factors are often specific to a geographic region or even a specific site. Emission factors are publicly available databases which are created and published by many different governmental and non-governmental organizations. For example, emission factor databases are published by the US Environmental Protection Agency, the Intergovernmental Panel on Climate Change, the Institute for Global Environmental Strategies, and the Climate Registry.

By their nature, emission factors are generalized and may not precisely represent the quantity of a pollutant released by a particular activity using a particular fuel, due to factors such as differences in fuel composition.

Applicant has discovered problems with current implementations of determining amounts of greenhouse gas emissions. Through applied effort, ingenuity, and innovation, many of these identified problems have been solved by developing solutions that are included in embodiments of the present disclosure, many examples of which are described in detail herein.

### BRIEF SUMMARY

In general, embodiments of the present disclosure provided herein provide improvements in determining amounts of greenhouse gas emissions. Other implementations for determining amounts of greenhouse gas emissions will be, or will become, apparent to one with skill in the art upon examination of the following figures and detailed description. It is intended that all such additional implementations be included within this description be within the scope of the disclosure and be protected by the following claims.

In accordance with a first aspect of the disclosure, a method is provided. The method may be computer-executed via one or more computing devices embodied in hardware, software, firmware, and/or a combination thereof, as described herein. An example implementation of the method is performed at a device with one or more processors and one or more memories. The example method includes determining an amount of each of a plurality of constituent components of a fuel being used by at least one physical component of a processing plant, wherein the amount of at least one constituent component is determined based at least in part on sensor data associated with operation of the at least one physical component, determining one or more properties of the fuel based at least in part on the amount of at least one constituent component, generating one or more emission factors for the fuel, determining, by at least a second sensor associated with the processing plant, an amount of the fuel used by the at least one component of the physical plant, using the one or more generated emission factors, determining an emitted amount of a corresponding one or more greenhouse gases; and causing outputting of the emitted amount, wherein the outputting of the emitted amount comprises one or more of transmission of the emitted amount to another system for processing and causing rendering of the emitted amount to at least one display. Each emission factor corresponds to a different greenhouse gas. Each emission factor is generated using at least one of the constituent components and at least one of the properties.

Additionally or alternatively, some example embodiments of the method further include determining a mixed lower heating value for each the plurality of constituent components based on a lower heating value of each the plurality of constituent components and a weight fraction of the amount of each the plurality of constituent components in a total amount of the constituent components, wherein each emission factor is generated further using a sum of the mixed lower heating values for all of the constituent components.

Additionally or alternatively, some example embodiments of the method further include determining a carbon dioxide equivalent of the emitted amount of at least one of the one or more greenhouse gases.

Additionally or alternatively, in some example embodiments of the method, the plurality of constituent components comprise one or more of carbon dioxide, water, nitrous oxide. nitrogen, methane, ethane, propane, i-butane, n-butane, i-pentane, n-pentane, hexane, heptane, octane, nonane, decane, hydrogen sulfide, and mercaptans.

Additionally or alternatively, in some example embodiments of the method, the one or more properties are selected from the group consisting of heating value and density.

Additionally or alternatively, in some example embodiments of the method, the one or more greenhouse gases is selected from the group consisting of carbon dioxide, nitrous oxide, and methane.

Additionally or alternatively, in some example embodiments of the method, the fuel used comprises fuel combusted and/or fuel released.

In accordance with another aspect of the disclosure, an example system is provided. In at least one example embodiment, an example system includes at least one processor and at least one memory. The at least one memory has computer program code stored thereon that, in execution with the at least one processor, configures the system to perform any one of the example methods described herein. In yet another example embodiment, an example system includes means for performing each step of any one of the example methods described herein.

In accordance with yet another aspect of the disclosure, an example computer program product is provided. The example computer program product includes at least one non-transitory computer-readable storage medium having computer program code stored thereon that, in execution with at least one processor, configures the at least one processor to perform any one of the example methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary block diagram of an environment in which embodiments of the present disclosure may operate;

FIG. 2 illustrates an exemplary block diagram of an example apparatus that may be specially configured in accordance with an example embodiment of the present disclosure;

FIG. 3 illustrates a flowchart including operational blocks of an example process for determining an amount of greenhouse gases emitted, in accordance with at least some example embodiments of the present disclosure;

FIG. 4 illustrates an exemplary block diagram of further components of an environment in which embodiments of the present disclosure may operate;

FIGS. 5A-C illustrate a flowchart including operational blocks of an example sub-process for generating custom emission factors, in accordance with at least some example embodiments of the present disclosure; and

FIG. 6 illustrates an example user interface providing greenhouse gas emission data, in accordance with at least some example embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

Various embodiments of the present disclosure provide for the calculation of one or more custom emission factors that correspond to the particular composition of the fuel being used (rather than corresponding generally to a type of fuel) in one or more greenhouse gas (GHG) producing activities to enable more accurate determination of GHG emissions. In example embodiments, each custom emission factor is specific to a corresponding GHG. Such GHGs include, but are not limited to, carbon dioxide, nitrous oxide, and methane. Conventional emission factors are based on an assumed, uniform fuel composition. Such conventional emission factors may not reflect the composition of the fuel actually being used in a GHG-producing activity. As such, the use of conventional emission factors may cause errors (undercounting or overcounting) when determining GHG emissions. Accurately determining GHG emissions is important for reporting purposes, determining adherence to industry and/or governmental standards, and/or gauging the success of emission-reduction efforts.

In example embodiments, the custom emission factors are multiplied by the amount of fuel consumed to more accurately determine a total emission for one or more corresponding GHGs. In example embodiments, a global warming potential is applied to each determined total emission to generate a carbon dioxide equivalent (CO₂e) for each GHG, the results of which may be summed to determine a total amount of CO₂e.

Embodiments of the present disclosure herein include systems, apparatuses, methods, and computer program products configured for and to perform one or more operations determining an amount of GHG emission. It should be readily appreciated that the embodiments of the apparatus, systems, methods, and computer program product described herein may be configured in various additional and alternative manners in addition to those expressly described herein.

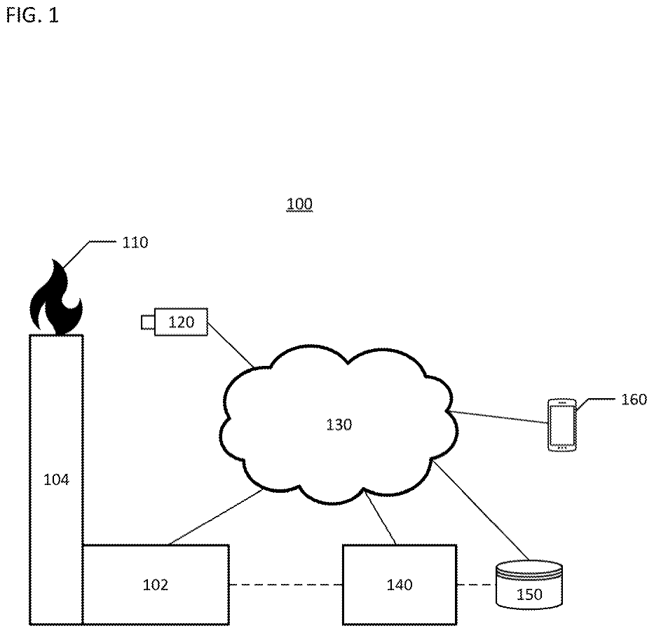

FIG. 1 illustrates an exemplary block diagram of an environment 100 in which embodiments of the present disclosure may operate. Specifically, FIG. 1 illustrates a plant 102 that may be associated with a flare stack 104 (“stack 104”). The stack 104 may be used to flare and/or vent one or more gases. These gases may include, but are not limited to, greenhouse gases. Flaring of gases may generate a flame 110. The flame 110 of a stack 104 may be observed, measured, analyzed by, and/or the like by one or more sensors 120 in accordance with operations and/or functions described herein. A sensor 120 may generate and/or transmit sensor data across a network 130 to an operations processing system 140. The operations processing system 140 may be electronically and/or communicatively coupled to one or more plant(s), for example to plant 102, one or more databases 150, and one or more user devices 160. In some embodiments, the plant 102 embodies or includes a different type of processing plant, and/or does not include the flare stack 104. For example, in some embodiments, the plant 102 includes any number of processing units that each perform different tasks for producing a final product (e.g., a blended, constructed, or otherwise combined product) from one or more input ingredients.

The plant 102 may, for example, be processing plant that receives and processes ingredients as inputs to create a final product, such as a hydrocarbon processing plant. The plant 102 may generate waste gases. In various embodiments, waste gases may be released to atmosphere, such as through a stack 104. Alternatively, waste gases may be flared when being released to atmosphere. Additionally, or alternatively, flaring and venting of gases may occur at locations other than a stack 104. For example, smaller quantities of gases at other locations may be released or may leak into the atmosphere. In some embodiments, locations other than a stack 104 where gases may be vented and/or flared may include well heads, safety release valves, pipe headers, and/or the like.

The plant 102 in some embodiments includes any number of individual processing units. The processing units may each embody an asset of the plant 102 that performs a particular function during operation of the plant 102. For example, in the example context of a particular oil refinery embodying the plant 102, the processing units may include a crude processing unit, a hydrotreating unit, an isomerization unit, a vapor recovery unit, a catalytic cracking unit, a aromatics reduction unit, a visbreaker unit, a storage tank, a blender, and/or the like that perform a particular operation for transforming, storing, and/or otherwise handling one or more input ingredient(s). In some embodiments, each individual unit embodying a component of the plant 102 is associated with a determinable location. The determinable location of a particular unit in some embodiments represents an absolute position (e.g., GPS coordinates, latitude and longitude locations, and/or the like) or a relative position (e.g., a point representation of the location of a unit from a local origin point corresponding to the plant 102). In some embodiments, a unit includes or otherwise is associated with a location sensor and/or software-driven location services that provide the location data representing the location corresponding to that unit. In other embodiments the location of a unit is stored and/or otherwise predetermined within a software environment, provided by a user and/or otherwise determinable to one or more systems, for example including the operations processing system 140.

Additionally or alternatively, in some embodiments, the plant 102 itself is associated with a determinable location. The determinable location of the plant 102 in some embodiments represents an absolute position (e.g., GPS coordinates, latitude and longitude locations, an address, and/or the like) or a relative position of the plant (e.g., an identifier representing the location of the plant 102 as compared to one or more other plants, an enterprise headquarters, or general description in the world for example based at least in part on continent, state, or other definable region). In some embodiments, the plant 102 includes or otherwise is associated with a location sensor and/or software-driven location services that provide the location data corresponding to the plant 102. In other embodiments, the location of the plant 102 is stored and/or otherwise determinable to one or more systems, for example including the operations processing system 140.

The flame 110 may be associated with flaring. Flaring involves the igniting and burning of concentrations of flammable gases. A gas may be comprised of a plurality of concentrations of individual gases, and some of these concentrations of individual gases may be flammable. Alternatively, a gas may be comprised of a concentration of an individual gas, which may or may not be flammable. In some embodiments, a gas may contain greenhouse gases, such as hydrocarbons. The hydrocarbons may be ignited by an ignition source, such as a pilot flame, when the gas passes by the ignition source. The ignited gas(es) may be referred to as flares, and this process may be referred to as flaring. In various embodiments, flaring may occur at the flaring stack 104, which may be at a high level of elevation from one or more other components of a plant 102, process area, piping, and the like associated with a site.

In embodiments with gases comprising hydrocarbons, the flaring of hydrocarbons will include lower emissions than the venting of the same gas(es). This is because flaring converts the hydrocarbons in the gas(es) to CO₂ and water while venting does not change the composition of the waste gas to water. Thus, the flaring may reduce the emissions of hydrocarbons into the atmosphere. In contrast to flaring, venting does not use combustion and, instead, is a direct release of gas(es) to the atmosphere. While FIG. 1 illustrates a flame 110, it will also be appreciated that by removing or omitting an ignition source, such as a pilot flame, gas(es) may be vented without flaring.

The one or more sensors 120 may include sensors to detect, measure, and/or analyze data associated with operation of one or more plant(s), for example the plant 102. In one such example context, the sensors detect, measure, and/or analyze a flame 110 and/or a gas emission, for example associated with a flaring and/or a venting. In some embodiments, a sensor 120 may include a camera, which may be configured to capture images and/or video in one or more spectrums of light. For example, a camera may be configured to capture images and/or video in the visible spectrum. Additional, and/or alternatively, a camera may be configured to capture images and/or video in the infrared spectrum. It will be appreciated that any number of sensor(s), sensor type(s), and/or the like may be utilized to monitor operations of a particular plant, and/or multiple plant(s).

In some embodiments, a sensor 120 (e.g., a camera) may be configured to perform or execute one or more operations and/or functions with determining a type, quantity, and/or volume of gas flared and/or emitted. For example, a camera may capture both visible light and infrared light to generate images and/or video of flaring. Based on these images and/or video of flaring, the camera may determine a type of gas being in a flame 110 as well as a volume of gas flared. In another example with a gas emission that is vented and not flared, a camera may capture both visible light and infrared light to generate images and/or video of venting. Based on these images and/or video of venting, the camera may determine a type of gas being in a column or cloud as well as a volume of gas vented. In various embodiments, a sensor 120 may generate sensor data (e.g., a camera generating images and/or video) and transmit the sensor data over a network 130.

The network 130 may be embodied in any of a myriad of network configurations. In some embodiments, the network 130 may be a public network (e.g., the Internet). In some embodiments, the network 130 may be a private a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

The operations processing system 140 may be located remotely or in proximity of a particular plant, for example the plant 102. In this regard, in some embodiments, the operations processing system 140 may be located remotely or in proximity to the emissions sources, such as flame 110. In some embodiments, the operations processing system 140 is configured via hardware, software, firmware, and/or a combination thereof, to perform data intake of one or more types of data associated with one or more plant(s), for example the plant 102. Additionally or alternatively, in some embodiments, the operations processing system 140 is configured via hardware, software, firmware, and/or a combination thereof, to generate and/or transmit command(s) that control, adjust, or otherwise impact operations of a particular plant or specific component(s) thereof, for example for controlling one or more operations of the plant 102. Additionally or alternatively still, in some embodiments, the operations processing system 140 is configured via hardware, software, firmware, and/or a combination thereof, to perform data reporting and/or other data output process(es) associated with monitoring or otherwise analyzing operations of one or more processing plant(s), for example for generating and/or outputting report(s) corresponding to the operations performed via the plant 102. For example, in various embodiments, the operations processing system 140 may be configured to execute and/or perform one or more operations and/or functions described herein.

The one or more databases 150 may be configured to receive, store, and/or transmit data. In various embodiments, the one or more databases may be associated with sensor data received from sensors 120. The sensor data may include historical sensor data as well as current and/or real-time sensor data. Additionally or alternatively, in some embodiments the one or more databases 150 store user inputted data associated with operations of one or more plant(s). In some embodiments, the one or more databases 150 store data associated with multiple individual plant(s), for example multiple plants associated with the same enterprise entity but located in different geographic locations across the world.

The one or more user devices 160 may be associated with users of the operations processing system 140. In various embodiments, the operations processing system 140 may generate and/or transmit a message, alert, or indication to a user via a user device 160. Additionally, or alternatively, a user device 160 may be utilized by a user to remotely access an operations processing system 140. This may be by, for example, an application operating on the user device 160. A user may access the operations processing system 140 remotely, including one or more visualizations, reports, and/or real-time displays.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the operations processing system 140 may include one or more databases 150, which may collectively be located in or at the plant 102.

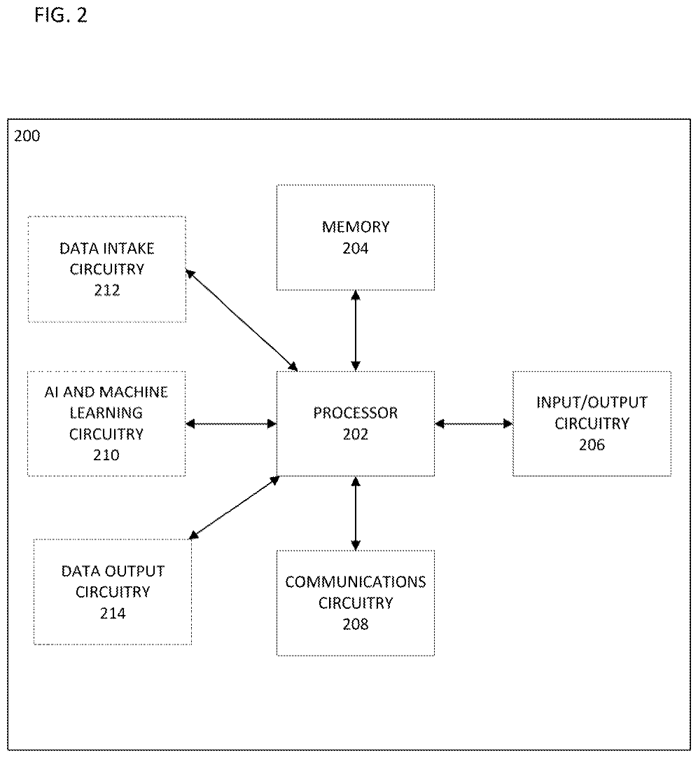

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. Examples of an apparatus 200 may include, but is not limited to, a sensor 120, an operations processing system 140, a database 150, and/or a user device 160. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as a computing apparatus 200 of an operations processing system 140 or of a user device 160 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of one or more plant(s). In some embodiments, the data intake circuitry 212 includes hardware, software, firmware, and/or a combination thereof, that communicates with one or more sensor(s). unit(s), and/or the like within a particular plant to receive particular data associated with such operations of the plant. The data intake circuitry 212 may support such operations for any number of individual plants. Additionally or alternatively, in some embodiments, the data intake circuitry 212 includes hardware, software, firmware, and/or a combination thereof, that retrieves particular data associated with one or more plant(s) from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured to facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect the AI and machine learning circuitry 210.

Various embodiments of the present disclosure provide for determining an amount of GHG emission from a plurality of GHG-producing activities, such as oil and natural gas production, heating, electricity generation, and manufacturing, such as may occur at the plant 102. Such activities may include, for example, the combustion, flaring, or venting of a carbon-based fuel (which may be a gas, a solid, or a liquid, including but not limited to natural gas, coal, or petroleum). In example embodiments, any suitable number of GHG-producing activities may be monitored for determining GHG emissions. The GHG-producing activities being monitored may be located at a one location or across multiple locations.

As the custom emission factors of example embodiments correspond to the particular composition of the fuel being used, in example embodiments the composition of the fuel being used for each GHG-producing activity is determined. In some embodiments, determining the composition of the fuel being used for each GHG-producing activity comprises determining one or more of the constituent components of the fuel and/or one or more properties of the fuel. In some embodiments, the one or more constituent components that are considered include, but are not limited to, any one or more of the following: carbon dioxide, nitrogen, methane, ethane, propane, i-butane, n-butane, i-pentane, n-pentane, hexane, heptane, octane, nonane, decane, water, and nitrous oxide. Various combinations of these components are found in carbon-based fuels (for example, most or all of these are often found in natural gas). In some embodiments, the one or more properties of the fuel comprise heating value and/or density. In some alternative embodiments, one or more of the constituent components may be determined at the atomic level. In such an alternative embodiment, the constituent components that are considered include, but are not limited to, carbon and nitrogen.

In some embodiments, the composition of the fuel being used for each GHG-producing activity is determined by laboratory analysis. In some embodiments, such laboratory analysis occurs on-site (i.e., at the same physical location as the GHG-producing activity). In some embodiments, such laboratory analysis occurs off-site (i.e., at a different physical location than the GHG-producing activity). In example embodiments, the results of the laboratory analysis are provided to an emission calculation device, such as the apparatus 200, (which may be on-site or off-site) as described herein.

In some embodiments, the composition of the fuel being used for each GHG-producing activity is determined by a data model. In some embodiments, such data model analysis occurs on-site (i.e., at the same physical location as the GHG-producing activity). In some embodiments, such data model analysis occurs off-site (i.e., at a different physical location than the GHG-producing activity). In example embodiments, the results of the data model analysis are provided to an emission calculation device (which may be on-site or off-site) as described herein.

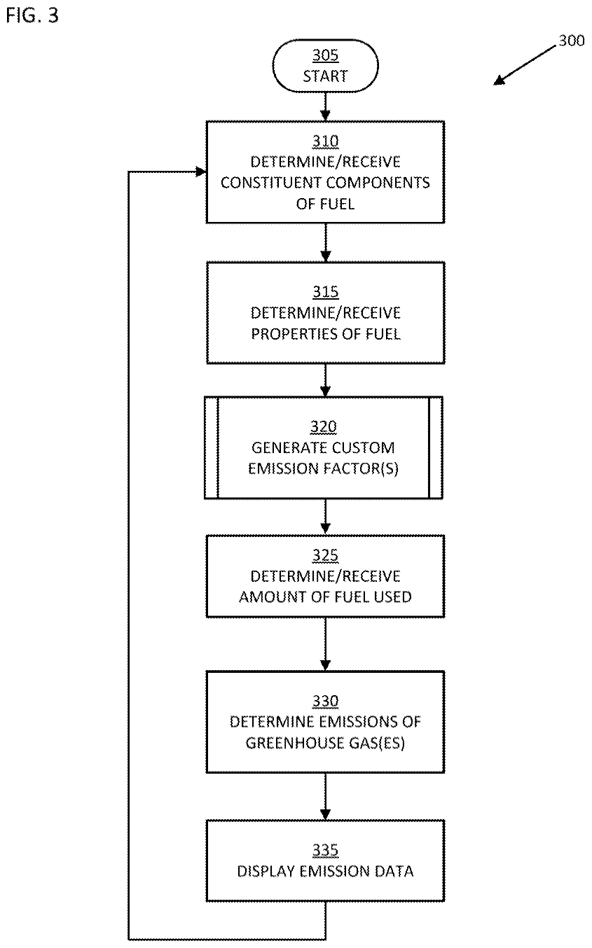

Reference will now be made to FIG. 3, which provides a flowchart illustrating example steps, processes, procedures, and/or operations in accordance with various embodiments of the present disclosure. Various methods described herein, including, for example, example methods as shown in FIG. 3, may provide various technical benefits and improvements. It is noted that each block of the flowchart, and combinations of blocks in the flowchart, may be implemented by various means such as hardware, firmware, circuitry and/or other devices associated with execution of software including one or more computer program instructions. For example, one or more of the procedures described in FIG. 3 may be embodied by computer program instructions, which may be stored by a non-transitory memory of an apparatus employing an embodiment of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

In FIG. 3, an example method is illustrated. In some embodiments, the example method determines GHG emissions based on custom emission factors which in turn are based on the actual fuel compositions used in a GHG-producing activity.

The example method 300 of FIG. 3 starts at step/operation 305. At step/operation 310, a processor (such as, but not limited to, the processor 202 of the apparatus 200 described above in connection with FIG. 2) determines or receives the constituent components of the fuel being used in a GHG-producing activity. In some embodiments, the weight fraction of each constituent component is determined (if all constituent components are identified, the total of the weight fractions should be 1). In one example embodiment, the fuel used is natural gas and the constituent components are one or more of carbon dioxide, water, nitrous oxide. nitrogen, methane, ethane, propane, i-butane, n-butane, i-pentane, n-pentane, hexane, heptane, octane, nonane, decane, hydrogen sulfide, and mercaptans.

As described above, in some embodiments the composition of the fuel being used for each GHG-producing activity is determined by laboratory analysis. In such embodiments, a sample amount of the fuel being used is extracted for analysis from the fuel supply being provided to the activity. In an example embodiment, the fuel sample is extracted via an extraction valve on a fuel supply pipe leading to the activity.

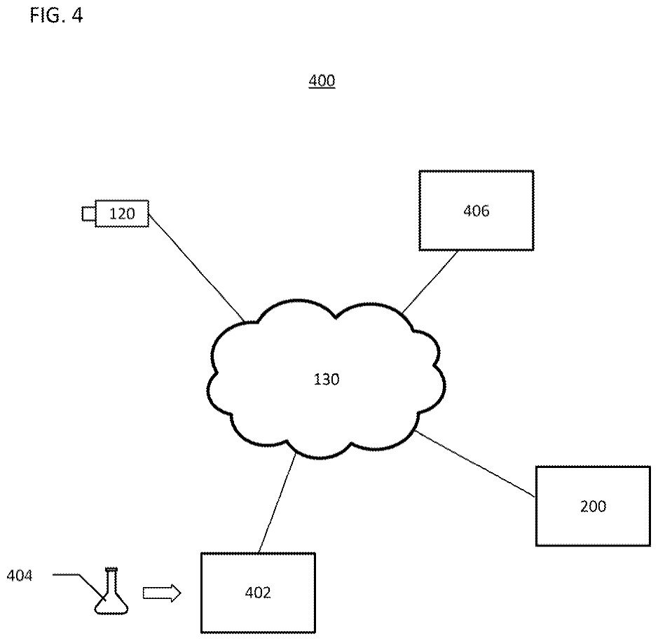

FIG. 4 depicts an exemplary block diagram of further components of an environment interacting, for example where the components of the environment interact to sample and analyze fuel used during a particular industrial operation/activity, such as may be performed in the plant 102, to determine emissions data as described herein. Referring now to FIG. 4, an extracted fuel sample 404 is provided to a fuel analyzer 402 to determine the constituent components of the fuel. In some embodiments, the fuel analyzer 402 is a conventional natural gas analyzer using gas chromatography. The analysis of the fuel, such as by the fuel analyzer 402, may occur on-site or off-site. In example embodiments, the results of the laboratory analysis are provided by the fuel analyzer 402, via the network 130, to an emission calculation device (such as the apparatus 200). In other example embodiments, the composition of the fuel being used for each GHG-producing activity is determined by a data model (such as, but not limited to, the AI and machine learning circuitry 210 of the apparatus 200 described above in connection with FIG. 2) using input from sensors (such as the sensors 120 described above in connection with FIG. 1) monitoring the GHG-producing activity. In example embodiments, the sensor data from the sensors 200 are provided via the network 130 to the apparatus 200.

At step/operation 315, a processor (such as, but not limited to, the processor 202 of the apparatus 200 described above in connection with FIG. 2) determines or receives the properties of the fuel being used in a GHG-producing activity. As described above, in some embodiments the apparatus 200 receives the constituent components and/or properties of the fuel used that were determined elsewhere, while in other embodiments the apparatus 200 determines the constituent components and/or properties of the fuel used based on data received, directly or indirectly, from the site(s) of the GHG-producing activity.

In one example embodiment, the properties of the fuel that are used to generate custom emission factors are density and heating value. In some embodiments (particularly involving oil and gas production), the Peng-Robinson Equation of State is used to determine the density and heating value of the fuel. In some embodiments (particularly involving a petrochemical plant), the Non-Random Two Liquid model is used to determine the density and heating value of the fuel. Other embodiments in other industries may use different models to determine the density and heating value of the fuel.

At step/operation 320, a processor (such as, but not limited to, the processor 202 of the apparatus 200 described above in connection with FIG. 2) generates one or more custom emission factors (EFs) specific to the fuel used.

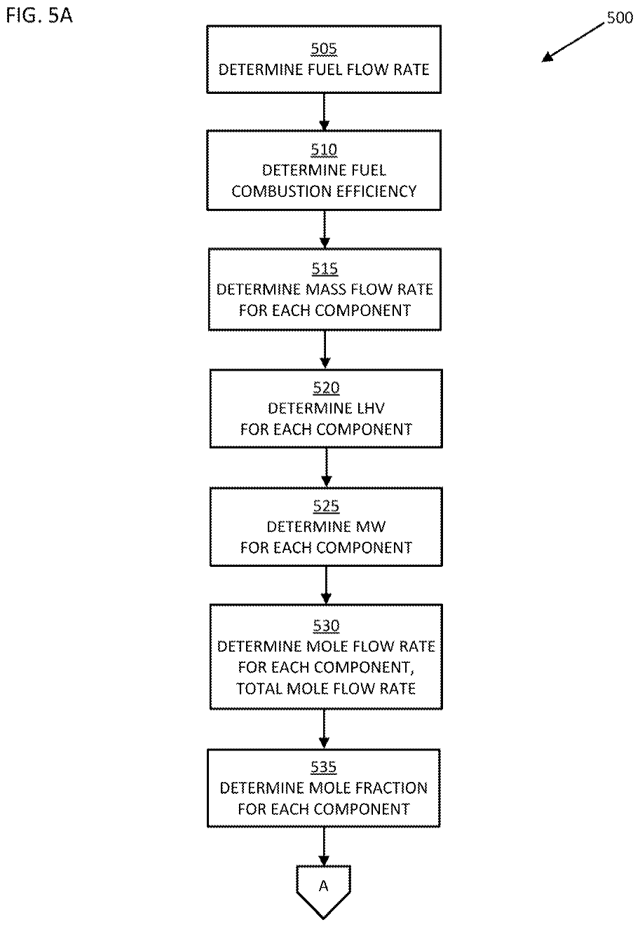

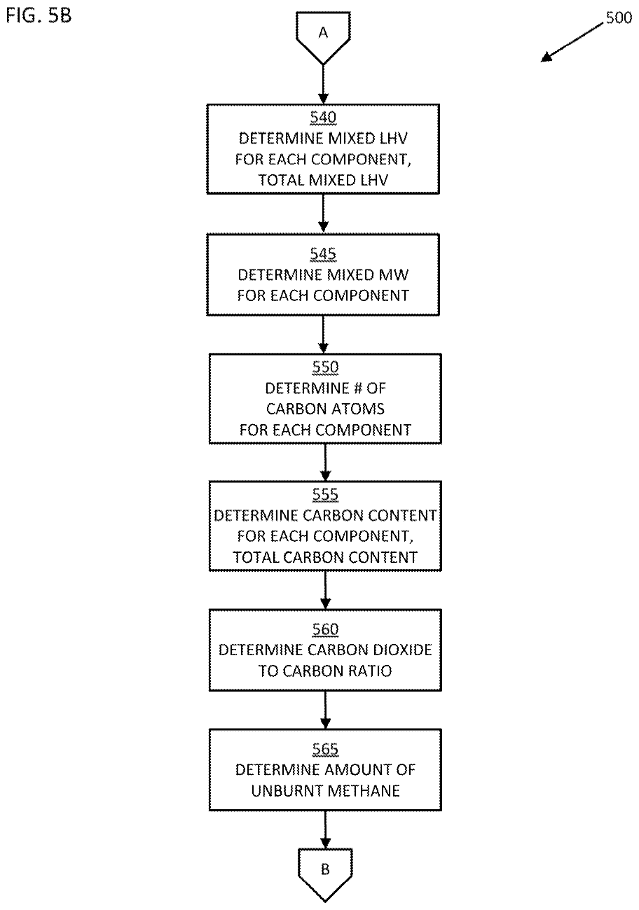

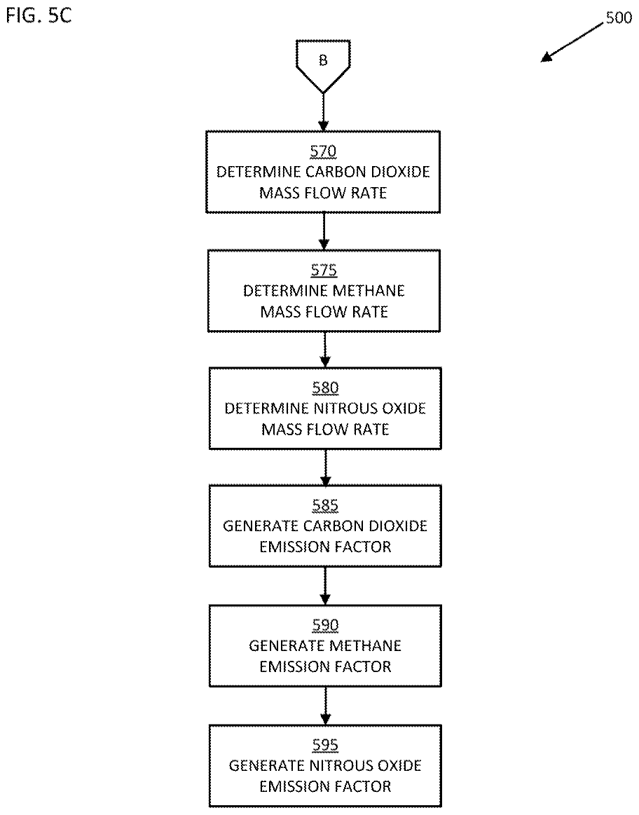

In an example embodiment, custom EFs are generated for carbon dioxide, methane, and nitrous oxide. Referring now to FIGS. 5A-C, a sub-process 500 for generating custom emission factors is illustrated. In example embodiments, some or all of the steps/operations illustrated in FIGS. 5A-C are performed (not necessarily performed in the order in which the steps are listed).

At step/operation 505, a processor (such as, but not limited to, the processor 202 of the apparatus 200 described above in connection with FIG. 2) determines the flow rate of the fuel being used in the activity (in kilograms per hour (kg/hr)), then divide by 3600 to determine the fuel flow rate (in kilograms per second (kg/sec)). In example embodiments, the flow rate of the fuel being used is captured by a meter 406 on a fuel supply pipe leading to the activity. In example embodiments, the fuel flow data from the meter 406 are provided via the network 130 to the apparatus 200. In some embodiments, the fuel flow rate is generated in a particular unit, for example but without limitation in kg/hr or kg/sec. It will be appreciated that in other embodiments, other algorithms, functions, and/or processes may be utilized to generate a fuel flow rate in any desired unit.

At step/operation 510, a processor (such as, but not limited to, the processor 202 of the apparatus 200 described above in connection with FIG. 2) determines the efficiency of the combustion of the fuel. In some embodiments having stationary combustion devices, combustion efficiency is determined by the fuel to air ratio during fuel combustion. In some embodiments, the fuel to air ratio is measured using input from sensors (such as the sensors 120 described above in connection with FIG. 1). In some embodiments, this is measured by the excess air percentage value after the combustion in a flue gas stream. In some embodiments in which flaring is occurring, combustion efficiency is determined by the ambient condition like wind speed and weather condition. In some embodiments, the ambient conditions are measured using input from sensors (such as the sensors 120 described above in connection with FIG. 1).

At step/operation 515, a processor (such as, but not limited to, the processor 202 of the apparatus 200 described above in connection with FIG. 2) determines, for each of the constituent components of the fuel (determined at step/operation 310), its mass flow rate. In some embodiments, the mass flow rate is determined by multiplying its weight fraction by the fuel flow rate. In some embodiments, the mass flow rate is generated in a particular unit, for example but without limitation in kg/hr. It will be appreciated that in other embodiments, other algorithms, functions, and/or processes may be utilized to generate a mass flow rate in any desired unit.

At step/operation 520, a processor (such as, but not limited to, the processor 202 of the apparatus 200 described above in connection with FIG. 2) determines, for each of the constituent components of the fuel, its lower heating value (LHV). In some embodiments, the LHV is determined by accessing a pre-established database of LHV values (such as may be stored in the memory 204 of the apparatus 200 described above in connection with FIG. 2) for each potential constituent component. LHV is the energy released during combustion of the fuel, excluding the latent heat content of the water vapor component of the products of combustion. In some embodiments, the LHV is generated in a particular unit, for example but without limitation in kilojoules per kilogram (KJ/kg). It will be appreciated that in other embodiments, other algorithms, functions, and/or processes may be utilized to generate an LHV in any desired unit.

At step/operation 525, a processor (such as, but not limited to, the processor 202 of the apparatus 200 described above in connection with FIG. 2) determines, for each of the constituent components of the fuel, its molecular weight (MW). In some embodiments, the MW is determined by accessing a pre-established database of MW values (such as may be stored in the memory 204 of the apparatus 200 described above in connection with FIG. 2) for each potential constituent component. In some embodiments, the MW is generated in a particular unit, for example but without limitation, in kilograms per kilomole (in kg/kmol). It will be appreciated that in other embodiments, other algorithms, functions, and/or processes may be utilized to generate a MW in any desired unit.

At step/operation 530, a processor (such as, but not limited to, the processor 202 of the apparatus 200 described above in connection with FIG. 2) determines, for each of the constituent components of the fuel, its mole flow rate. In some embodiments, the mole flow rate is determined by dividing its mass flow rate by its molecular weight. In some embodiments, the results of the mole flow rate for each constituent component are summed to determine the total mole flow rate (in kmol/hr), then divided by 3600 to determine the total mole flow rate in kmol/sec. In some embodiments, the mole flow rate and total mole flow rate are generated in a particular unit, for example but without limitation in kmol/hr or kmol/sec. It will be appreciated that in other embodiments, other algorithms, functions, and/or processes may be utilized to generate a mole flow rate and a total mole flow rate in any desired unit.

At step/operation 535, a processor (such as, but not limited to, the processor 202 of the apparatus 200 described above in connection with FIG. 2) determines, for each of the constituent components of the fuel, its mole fraction (no units). In some embodiments, the mole fraction is determined by dividing its mole flow rate by the total mole flow rate.

At step/operation 540, a processor (such as, but not limited to, the processor 202 of the apparatus 200 described above in connection with FIG. 2) determines, for each of the constituent components of the fuel, its mixed LHV. In some embodiments, the mixed LHV is determined by multiplying its weight fraction by its LHV, and then summing the results to determine the total mixed LHV. In some embodiments, the mixed LHV and the total mixed LHV are generated in a particular unit, for example but without limitation in kJ/kg. It will be appreciated that in other embodiments, other algorithms, functions, and/or processes may be utilized to generate a mixed LHV and a total mixed LHV in any desired unit. Mixed LHV is an important factor in generating custom EFs.

At step/operation 545, a processor (such as, but not limited to, the processor 202 of the apparatus 200 described above in connection with FIG. 2) determines, for each of the constituent components of the fuel, its mixed MW. In some embodiments, the mixed MW is determined by multiplying its mole fraction by its MW. In some embodiments, the mixed MW is generated in a particular unit, for example but without limitation in kg/kmol. It will be appreciated that in other embodiments, other algorithms, functions, and/or processes may be utilized to generate a mixed MW in any desired unit.

At step/operation 550, a processor (such as, but not limited to, the processor 202 of the apparatus 200 described above in connection with FIG. 2) determines, for each of the constituent components of the fuel, its number of carbon atoms (“C#”) (no units). For example, carbon dioxide has one carbon atom, ethane has two carbon atoms, and nitrous oxide has no carbon atoms. In some embodiments, the C# is determined by accessing a pre-established database of C# values (such as may be stored in the memory 204 of the apparatus 200 described above in connection with FIG. 2) for each potential constituent component.

At step/operation 555, a processor (such as, but not limited to, the processor 202 of the apparatus 200 described above in connection with FIG. 2) determines, for each of the constituent components of the fuel, its carbon content. In some embodiments, the carbon content is determined by multiplying its C# by its mole fraction by the atomic weight of carbon by the combustion efficiency, then divide by 100. In some embodiments, the results are summed to determine the total carbon content. In some embodiments, the carbon content and total carbon content are generated in a particular unit, for example but without limitation in kg/kmol. It will be appreciated that in other embodiments, other algorithms, functions, and/or processes may be utilized to generate a carbon content and a total carbon content in any desired unit.

At step/operation 560, a processor (such as, but not limited to, the processor 202 of the apparatus 200 described above in connection with FIG. 2) determines the carbon dioxide to carbon ratio (˜44/12) (no units). In some embodiments, the carbon dioxide to carbon ratio is a constant that is pre-determined and pre-stored (such as in the memory 204 of the apparatus 200 described above in connection with FIG. 2).

At step/operation 565, a processor (such as, but not limited to, the processor 202 of the apparatus 200 described above in connection with FIG. 2) determines the amount of unburnt methane (CH₄). In some embodiments, the amount of unburnt methane is determined by multiplying (1−(combustion efficiency/100)) by the mass flow rate of methane and dividing by 3600. In some embodiments, the amount of unburnt methane is generated in a particular unit, for example but without limitation in kg/sec. It will be appreciated that in other embodiments, other algorithms, functions, and/or processes may be utilized to generate an amount of unburnt methane in any desired unit.

At step/operation 570, a processor (such as, but not limited to, the processor 202 of the apparatus 200 described above in connection with FIG. 2) determines the mass flow rate of carbon dioxide (CO₂). In some embodiments, the mass flow rate of carbon dioxide is determined by multiplying the total carbon content by the carbon dioxide to carbon ratio by the total mole flow rate in kmol/sec. In some embodiments, the mass flow rate of carbon dioxide is generated in a particular unit, for example but without limitation in kg/sec. It will be appreciated that in other embodiments, other algorithms, functions, and/or processes may be utilized to generate a mass flow rate of carbon dioxide in any desired unit.

At step/operation 575, a processor (such as, but not limited to, the processor 202 of the apparatus 200 described above in connection with FIG. 2) determines the mass flow rate of methane (CH₄) In some embodiments, the mass flow rate of methane is the amount of unburnt methane determined above. In some embodiments, the mass flow rate of methane is generated in a particular unit, for example but without limitation in kg/sec. It will be appreciated that in other embodiments, other algorithms, functions, and/or processes may be utilized to generate a mass flow rate of methane in any desired unit.

At step/operation 580, a processor (such as, but not limited to, the processor 202 of the apparatus 200 described above in connection with FIG. 2) determines the mass flow rate of nitrous oxide (N₂O). In some embodiments, the mass flow rate of nitrous oxide is determined by dividing its mass flow in kg/hr by 3600. In some embodiments, the mass flow rate of nitrous oxide is generated in a particular unit, for example but without limitation in kg/sec. It will be appreciated that in other embodiments, other algorithms, functions, and/or processes may be utilized to generate a mass flow rate of nitrous oxide in any desired unit.

At step/operation 585, a processor (such as, but not limited to, the processor 202 of the apparatus 200 described above in connection with FIG. 2) generates the emission factor of carbon dioxide (EF_{CO}_{₂}). In some embodiments, the emission factor of carbon dioxide is determined by dividing the mass flow rate of carbon dioxide (in kg/sec) by the multiple of the total mixed LHV (in kJ/kg) and the fuel flow rate (in kg/sec). In some embodiments, the emission factor of carbon dioxide is generated in a particular unit, for example but without limitation in kg/kJ. It will be appreciated that in other embodiments, other algorithms, functions, and/or processes may be utilized to generate an emission factor of carbon dioxide in any desired unit.

At step/operation 590, a processor (such as, but not limited to, the processor 202 of the apparatus 200 described above in connection with FIG. 2) generates the emission factor of methane (EF_{CH}_{₄}). In some embodiments, the emission factor of methane is determined by dividing the mass flow rate of methane (in kg/sec) by the multiple of the total mixed LHV (in KJ/kg) and the fuel flow rate (in kg/sec). In some embodiments, the emission factor of methane is generated in a particular unit, for example but without limitation in kg/kJ. It will be appreciated that in other embodiments, other algorithms, functions, and/or processes may be utilized to generate an emission factor of methane in any desired unit.

At step/operation 595, a processor (such as, but not limited to, the processor 202 of the apparatus 200 described above in connection with FIG. 2) generates the emission factor of nitrous oxide (EF_{N}_{₂}_{O}). In some embodiments, the emission factor of nitrous oxide is determined by dividing the mass flow rate of nitrous oxide (in kg/sec) by the multiple of the total mixed LHV (in KJ/kg) and the fuel flow rate (in kg/sec). In some embodiments, the emission factor of nitrous oxide is generated in a particular unit, for example but without limitation in kg/kJ. It will be appreciated that in other embodiments, other algorithms, functions, and/or processes may be utilized to generate an emission factor of nitrous oxide in any desired unit.

In some embodiments, the density of the fuel is used to convert the emission factors into cubic centimeters per gigajoule (cm³/GJ) or any other volume/energy units. In some embodiments, the density of the fuel is generated in a particular unit, for example but without limitation in cm³/g. It will be appreciated that in other embodiments, other algorithms, functions, and/or processes may be utilized to generate a density of the fuel in any desired unit.

At step/operation 325, a processor (such as, but not limited to, the processor 202 of the apparatus 200 described above in connection with FIG. 2) determines or receives the amount of the fuel being used in a GHG-producing activity. In example embodiments, the amount of fuel being used is captured by a meter 406 on a fuel supply pipe leading to the activity. In example embodiments, the fuel usage data from the meter 406 are provided via the network 130 to the apparatus 200.

At step/operation 330, a processor (such as, but not limited to, the processor 202 of the apparatus 200 described above in connection with FIG. 2) uses the one or more custom EFs to determine the emissions of GHGs. In an example embodiment, the custom emission factor(s) determined at step/operation 320 are multiplied by the amount of fuel used (determined at step/operation 325) to determine the emission(s) for each one or more corresponding GHG. In some embodiments, a global warming potential (GWP) is applied to the emission(s) determined at step/operation 230 to determine a carbon dioxide equivalent (CO₂e) for each GHG, the results of which may be summed to determine a total amount of CO₂e. A global warming potential is a ratio of the effect of a quantity of a greenhouse gas on climate change compared with an equal quantity of carbon dioxide. In an example embodiment, the GWP of carbon dioxide is 1, the GWP of methane is 25, and the GWP of nitrous oxide is 298. Estimates of GWP values over 20, 100, and 500 years are periodically compiled and revised in reports from the Intergovernmental Panel on Climate Change (IPCC).

At step/operation 335, a processor (such as, but not limited to, the processor 202 of the apparatus 200 described above in connection with FIG. 2) displays the GHG emissions. In some embodiments, the processor causes displaying on a display associated with the processor or a connected device, such as, but not limited to, on the user device 160 described above in connection with FIG. 1, for a user or users to view. Optionally, in some embodiments, the processor additionally or alternatively displays the carbon dioxide equivalent (CO₂e) for each GHG and/or a total amount of CO₂e).

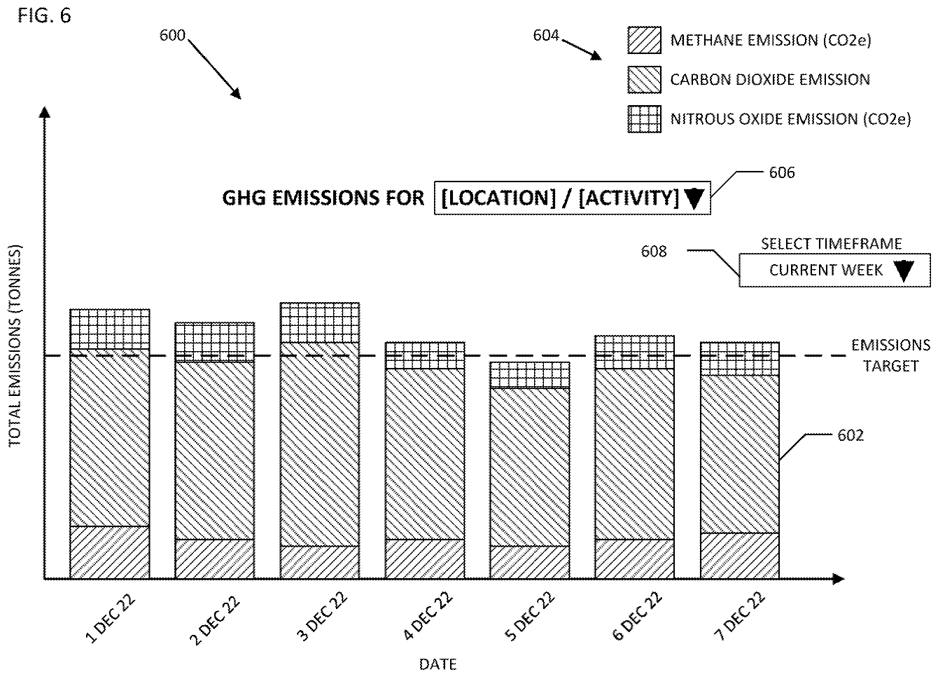

For example, in some embodiments, the GHG emissions are utilized to cause rendering of a particular user interface based at least in part on such data. Referring now to FIG. 6, an example user interface 600 includes a graphical representation of the greenhouse gas emissions for a location and/or activity as generated using an example embodiment of the present disclosure. In the example embodiment of FIG. 6, a stacked bar chart of the emissions of three different GHGs (methane, carbon dioxide, and nitrous oxide) is illustrated. In the example embodiment illustrated, the X-axis shows the covered timeframe (which, in some embodiments, is user-selectable as described below) and the Y-axis shows the total amount of emissions (in tonnes). In the example embodiment illustrated, each of the stacked bars 602 represent the GHG emissions on a different day. In the example embodiment illustrated, a key 604 is provided to indicate the different patterns used for each portion of the stacked bars 602 indicating each different greenhouse gas. In the example embodiment illustrated, a dropdown menu 606 enables a user to select a location and/or GHG-producing activity for which to display its greenhouse gas emissions. In the example embodiment illustrated, a dropdown menu 608 enables a user to select a timeframe (e.g., current week, current month, year-to-date) to display.

In some alternative embodiments, different user interfaces are displayed which comprise different and/or additional types of graphical/visual representations, different and/or additional user interface controls, different and/or additional data, and/or the like.

In some embodiments, steps/operations 310 through 335 are continuously repeated while the GHG-producing activity is occurring. In some embodiments, steps/operations 310 through 335 are repeated at predetermined intervals (e.g., every day, every week, or every other week) while the GHG-producing activity is occurring. In some example embodiments, steps/operations 310 through 335 are repeated upon request by a user. In some example embodiments, steps/operations 310 through 335 are repeated.

### CONCLUSION

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
determining an amount of each of a plurality of constituent components of a fuel being used by at least one physical component of a processing plant, wherein the amount of at least one constituent component is determined based at least in part on sensor data associated with operation of the at least one physical component;
determining one or more properties of the fuel based at least in part on the amount of at least one constituent component;
generating one or more emission factors for the fuel, each emission factor corresponding to a different greenhouse gas, each emission factor generated using at least one of the constituent components and at least one of the properties;
determining, by at least a second sensor associated with the processing plant, an amount of the fuel used by the at least one component of the physical plant;
using the one or more generated emission factors, determining an emitted amount of a corresponding one or more greenhouse gases; and
causing outputting of the emitted amount, wherein the outputting of the emitted amount comprises one or more of transmission of the emitted amount to another system for processing and causing rendering of the emitted amount to at least one display.

2. The method of claim 1, further comprising:
determining a mixed lower heating value for each the plurality of constituent components based on a lower heating value of each the plurality of constituent components and a weight fraction of the amount of each the plurality of constituent components in a total amount of the constituent components;
wherein each emission factor is generated further using a sum of the mixed lower heating values for all of the constituent components.

3. The method of claim 1, further comprising:
determining a carbon dioxide equivalent of the emitted amount of at least one of the one or more greenhouse gases.

4. The method of claim 1, wherein the plurality of constituent components comprise one or more of carbon dioxide, water, nitrous oxide, nitrogen, methane, ethane, propane, i-butane, n-butane, i-pentane, n-pentane, hexane, heptane, octane, nonane, decane, hydrogen sulfide, and mercaptans.

5. The method of claim 4, wherein the one or more properties are selected from the group consisting of heating value and density.

6. The method of claim 1, wherein the one or more greenhouse gases is selected from the group consisting of carbon dioxide, nitrous oxide, and methane.

7. The method of claim 1, wherein the fuel used comprises fuel combusted and/or fuel released.

8. An apparatus comprising at least one processor and at least one non-transitory memory comprising program code, wherein the at least one non-transitory memory and the program code are configured to, with the at least one processor, cause the apparatus to at least:
determine an amount of each of a plurality of constituent components of a fuel being used by at least one physical component of a processing plant, wherein the amount of at least one constituent component is determined based at least in part on sensor data associated with operation of the at least one physical component;
determine one or more properties of the fuel based at least in part on the amount of at least one constituent component;
generate one or more emission factors for the fuel, each emission factor corresponding to a different greenhouse gas, each emission factor generated using at least one of the constituent components and at least one of the properties;
determine, by at least a second sensor associated with the processing plant, an amount of the fuel used by the at least one component of the physical plant;
using the one or more generated emission factors, determine an emitted amount of a corresponding one or more greenhouse gases; and
causing outputting of the emitted amount, wherein the outputting of the emitted amount comprises one or more of transmission of the emitted amount to another system for processing and causing rendering of the emitted amount to at least one display.

9. The apparatus of claim 8, wherein the at least one non-transitory memory and the program code are configured to, with the at least one processor, cause the apparatus to further:
determine a mixed lower heating value for each the plurality of constituent components based on a lower heating value of each the plurality of constituent components and a weight fraction of the amount of each the plurality of constituent components in a total amount of the constituent components;
wherein each emission factor is generated further using a sum of the mixed lower heating values for all of the constituent components.

10. The apparatus of claim 8, wherein the at least one non-transitory memory and the program code are configured to, with the at least one processor, cause the apparatus to further:
determine a carbon dioxide equivalent of the emitted amount of at least one of the one or more greenhouse gases.

11. The apparatus of claim 8, wherein the plurality of constituent components comprise one or more of carbon dioxide, water, nitrous oxide, nitrogen, methane, ethane, propane, i-butane, n-butane, i-pentane, n-pentane, hexane, heptane, octane, nonane, decane, hydrogen sulfide, and mercaptans.

12. The apparatus of claim 11, wherein the one or more properties are selected from the group consisting of heating value and density.

13. The apparatus of claim 8, wherein the one or more greenhouse gases is selected from the group consisting of carbon dioxide, nitrous oxide, and methane.

14. The apparatus of claim 8, wherein the fuel used comprises fuel combusted and/or fuel released.

15. A computer program product comprising at least one non-transitory computer-readable storage medium having computer-readable program code portions stored therein, the computer-readable program code portions comprising an executable portion configured to:
determine an amount of each of a plurality of constituent components of a fuel being used by at least one physical component of a processing plant, wherein the amount of at least one constituent component is determined based at least in part on sensor data associated with operation of the at least one physical component;
determine one or more properties of the fuel based at least in part on the amount of at least one constituent component;
generate one or more emission factors for the fuel, each emission factor corresponding to a different greenhouse gas, each emission factor generated using at least one of the constituent components and at least one of the properties;
determine, by at least a second sensor associated with the processing plant, an amount of the fuel used by the at least one component of the physical plant;
using the one or more generated emission factors, determine an emitted amount of a corresponding one or more greenhouse gases; and
causing outputting of the emitted amount, wherein the outputting of the emitted amount comprises one or more of transmission of the emitted amount to another system for processing and causing rendering of the emitted amount to at least one display.

16. The computer program product of claim 15, wherein the computer-readable program code portions comprise an executable portion further configured to:
determine a mixed lower heating value for each the plurality of constituent components based on a lower heating value of each the plurality of constituent components and a weight fraction of the amount of each the plurality of constituent components in a total amount of the constituent components;
wherein each emission factor is generated further using a sum of the mixed lower heating values for all of the constituent components.

17. The computer program product of claim 15, wherein the computer-readable program code portions comprise an executable portion further configured to:
determine a carbon dioxide equivalent of the emitted amount of at least one of the one or more greenhouse gases.

18. The computer program product of claim 15, wherein the plurality of constituent components comprise one or more of carbon dioxide, water, nitrous oxide, nitrogen, methane, ethane, propane, i-butane, n-butane, i-pentane, n-pentane, hexane, heptane, octane, nonane, decane, hydrogen sulfide, and mercaptans.

19. The computer program product of claim 18, wherein the one or more properties are selected from the group consisting of heating value and density.

20. The computer program product of claim 15, wherein the one or more greenhouse gases is selected from the group consisting of carbon dioxide, nitrous oxide, and methane.
